(19) United States
(12) Patent Application Publication
(10) Pub. No.: US 2006/0060071 A1
(43) Pub. Date: Mar. 23, 2006

(54) Parameter setting apparatus and method

(75) Inventors: Kojiro Kato, Hamamatsu-Shi (JP); Ryotaro Sugimoto, Shizuoka-shi (JP); Takeshi Ando, Hamamatsu-shi (JP); Seiji Abe, Hamamatsu-shi (JP); Akiko Shinjo, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-Shi (JP)

(21) Appl. No.: 11/228,846

(22) Filed: Sep. 15, 2005

(30) Foreign Application Priority Data
Sep. 21, 2004 (JP) 2004-273529

(51) Int. Cl. G10H 7/00

(52) U.S. Cl. 84/645

(57) ABSTRACT

Any one of a plurality of functions is selected via a selection section, in response to which a plurality of parameter setting operators are each caused to become operable to set a different type of parameter among a plurality of types pf parameters pertaining to the selected one function. Color indicator is provided in correspondence with at least two or more of the operators. Specific colors are assigned to the individual functions, and, in accordance with the function selection via the selection section, the color indicator is caused to indicate the specific color assigned to the selected function.

### BACKGROUND OF THE INVENTION

The present invention relates generally to parameter setting apparatus for setting a multiplicity of parameters by operation of a plurality of operators, and more particularly an improved parameter setting apparatus suited for use with a mixing console which sets a multiplicity of sound parameters and then mixes a plurality of signals via a plurality of bus systems to generate appropriate sounds.

Mixing consoles are used in broadcasting stations, recording studios, concert halls, etc. There have been a need for the mixing consoles to perform various control (processing) on a multiplicity of signals in order to output sound signals of various musical instruments and vocal sound signals. A multiplicity of types of operators are provided on an operation panel, and in order to satisfy the above-mentioned need, it is necessary to enhance the operativity of the operation panel and thereby lessen burdens on a human operator.

Japanese Patent Application Laid-open Publication No. HEI-9-198953, for example, discloses a technique, in accordance with which a plurality of fader knobs are colored in different colors, such as red, green and yellow, so that the positions of the individual fader knobs can be identified by the different colors. If operators can be visually identified by their respective colors as disclosed in the HEI-9-198953 publication, burdens on a human operator in manipulating the multiplicity of the operators can be significantly lessened.

Further, examples of the digital mixers known today include those which include first and second operator groups and in which a desired one of a plurality of functions is selected via the first operator group and a plurality of sound parameters pertaining to the selected function are set via the second operator group. Through various combinations of the operators of the first and second operator groups, such arrangements can set a great many sound parameters with a reduced number of the operators. Some of the operators of the first operator group are equipped with respective indicators each indicating that the corresponding operator (and hence function) is currently selected.

Further, in the field of electronic musical instruments, it is also popularly known to set a desired tone color via any of draw bars (slide volume controls) and set a desired tone parameter, such as a tone volume, via any of sliding-type operators (slide volume controls) prior to or during a performance, and slide volume controls are used as the draw bars and sliding-type operators on an operation panel. It is also possible to use such volume controls to set a plurality of parameters.

In operating any of the operators of the second operator group in the conventional digital mixers, however, the human operator must check the indicator of the corresponding operator of the first operator group in order to confirm what function is currently selected, which would unavoidably prevent quick operation of the operators and could lead to erroneous operation.

### SUMMARY OF THE INVENTION

In view of the foregoing, it is an object of the present invention to provide a technique for enhancing the operativity of a parameter setting apparatus, constructed to set parameters in response to operation of operators, so as to allow a human operator to intuitively perform quick operation of the setting apparatus.

In order to accomplish the above-mentioned object, the present invention provides an improved parameter setting apparatus, which comprises: a selection section that selects any one of a plurality of functions; an operator group including a plurality of operators, each of the operators in the operator group being operable to set a type of parameter among a plurality of types of parameters pertaining to the selected one function; a color indicator provided in correspondence with at least two or more of the operators in the operator group; and a color change control section that changes the color to be indicated by the color indicator. Different or specific colors are assigned to the individual functions, and, in accordance with function selection via the selection section, the color change control section causes the color indicator to indicate the specific color assigned to the selected function. With such arrangements of the present invention, a human operator can intuitively identify the currently-selected function from the indicated color and thereby perform quick operation; thus, an enhanced operability of the setting apparatus can be achieved. Also, the human operator can readily know that a set of two or more operators corresponds to the selected function.

In one embodiment, the selection section includes a plurality of selecting operators, and each of the selecting operators is operable to select any one of the plurality of functions. In embodiments to be described later, what corresponds to the selection section including the plurality of selecting operators is a “first operator group”, and what corresponds to the operator group including the plurality of parameter setting operators is a “second operator group”.

According to another aspect of the present invention, there is provided a parameter setting apparatus, which comprises: a selection section that selects any one of a plurality of functions; an operator operable, in accordance with function selection by the selection section, to set a parameter pertaining to the selected function, the operator including a fixed section and a movable section so that a parameter value is set by movement of the movable section; a color indicator provided in correspondence with the operator, the color indicator including a multi-color light emitting device provided in the fixed section of the operator and a light guide member provided in the movable section, light emitted by the multi-color light emitting device being irradiated externally from a surface of the movable section through the light guide member; and a color change control section that changes the color to be indicated by the color indicator. Different or specific colors are assigned to the individual functions, and, in accordance with the function selection via the selection section, the color change control section causes the color indicator to indicate the specific color assigned to the selected function. Such arrangements too allows a human operator to intuitively identify the currently-selected function from the indicated color and thereby perform quick operation of the setting apparatus; thus, an enhanced operability of the setting apparatus can be achieved. The movement of the movable section relative to the fixed section may be rotational movement relative to the fixed section, in which case the light emitted by the light emitting device in the fixed section can be readily directed or guided as desired, by providing the light guide member at the rotation center of the movable section.

According to still another aspect of the present invention, there is provided a parameter setting apparatus, which comprises: a selection section that selects any one of a plurality of functions; an operator operable, in accordance with function selection by the selection section, to set a parameter pertaining to the function selected via the selection section, the operator including a fixed section and a movable section so that a parameter value is set by movement of the movable section; a color indicator provided in correspondence with the operator, the color indicator including a multi-color light emitting device provided in the movable section of the operator; and a color change control section that changes the color to be indicated by the color indicator. Specific colors are assigned to the individual functions, and, in accordance with the function selection via the selection section, the color change control section causes the color indicator to indicate the specific color assigned to the selected function. Such arrangements too allows a human operator to intuitively identify the currently-selected function from the indicated color and thereby perform quick operation of the setting apparatus; thus, an enhanced operability of the setting apparatus can be achieved. For example, the movable section of the operator may be constructed to slide relative to the fixed section.

In a preferred embodiment, the parameter setting apparatus of the present invention is used for setting signal processing parameters in an audio mixer. The parameter setting apparatus of the invention can achieve even further advantages if applied to a mixing console apparatus where a greater number of sound parameters are to be set.

The present invention may be constructed and implemented not only as the apparatus invention as discussed above but also as a method invention. Also, the present invention may be arranged and implemented as a software program for execution by a processor such as a computer or DSP, as well as a storage medium storing such a software program. Further, the processor used in the present invention may comprise a dedicated processor with dedicated logic built in hardware, not to mention a computer or other general-purpose type processor capable of running a desired software program.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

For better understanding of the objects and other features of the present invention, its preferred embodiments will be described hereinbelow in greater detail with reference to the accompanying drawings, in which:

FIG. 1 is an enlarged diagram of a parameter setting unit of a mixing console in an embodiment of the present invention;

FIG. 2 is a diagram showing an entire panel surface of the mixing console in the embodiment of the present invention;

FIG. 3 is a block diagram showing part of circuitry of the mixing console in the embodiment of the present invention;

FIG. 4 is a partially-taken-way perspective view of a rotary volume control device of the mixing console in the embodiment of the present invention;

FIG. 5 is a circuit diagram of the parameter setting unit of the mixing console in the embodiment of the present invention;

FIG. 6 is a fragmentary exploded perspective view of a slide volume control device of the mixing console in the embodiment of the present invention;

FIG. 7 is a fragmentary perspective view of a moving block in the slide volume control device;

FIG. 8 is a circuit diagram of a parameter setting apparatus using the above-described slide volume control device;

FIG. 9 is a fragmentary perspective view showing another embodiment of the non-contact-type slide volume control device in the embodiment of the present invention;

FIG. 10 is a diagram explanatory of a clearance between a magnetic sensor and a movement guide in the embodiment; and

FIG. 11 is a sectional view showing modifications of the movement guide in the embodiment.

### DETAILED DESCRIPTION OF THE INVENTION

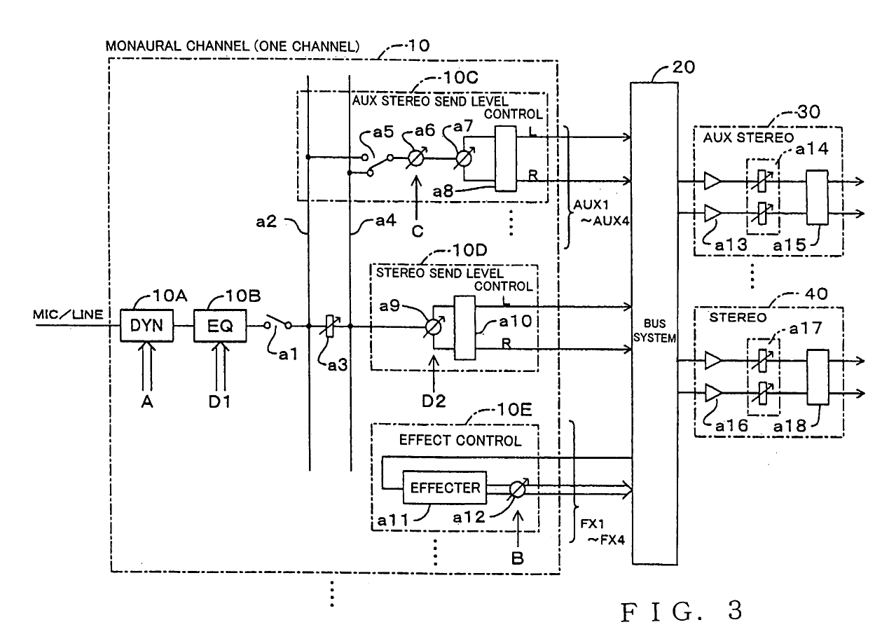

FIG. 3 is a block diagram showing part of circuitry of a mixing console to which is applied a parameter setting apparatus in accordance with an embodiment of the present invention; in this figure, circuitry for only one of a multiplicity of input channels is illustrated. Each switch, volume control circuit, fader circuit, etc. in the illustrated circuitry operates electronically. For example, for each of the volume control circuits, a parameter is set in accordance with a signal corresponding to a rotating amount and direction of a volume control operator of a rotary encoder to be later described, and for each of the fader circuits, a parameter is set in accordance with a signal corresponding to a sliding position of a slide operator of a slide volume control device. Namely, parameters for the individual circuits are set in accordance with output signals of encoders that operate in response to operation of corresponding operators provided on an operation panel, and output levels etc. of the circuits are determined in accordance with the thus-set parameters.

In FIG. 3, a monaural sound signal (microphone input/line input) of one channel is input to the monaural input channel 10, where the input signal is then delivered to a first common signal line a2 via a dynamics circuit (DYN) 10A, equalizer circuit (EQ) 10B and channel-ON switch al. After that, the input signal is passed via a fader circuit a3 to a second common signal line a4. The signals thus delivered to the first and second common signal lines a2 and a4 are supplied to an AUX stereo send level control circuit 10C and stereo send level control circuit 10D.

For the dynamics circuit 10A, there are set various parameters, such as a total output level of the input signal, a threshold level indicative of an upper limit of a dynamic range, an input/output ratio and an attack indicative of a delay amount with which to cause the input to rise following another input channel to be paired with the input channel in question, and a signal corresponding to the thus-set parameters is output to the equalizer circuit 10B. For the equalizer circuit 10B, there are set filter characteristics for four frequency bands, i.e. low band, low-middle band, high-middle band and high band, and the input signal is passed to the channel-ON switch al in accordance with the thus-set filter characteristics. Each of the parameters for the dynamics circuit 10A (inputs A) and each of the parameters for setting the filter characteristics for the equalizer circuit 10B (inputs D1) are set via a parameter setting unit 100A that will be later described in detail.

Further, in the AUX stereo send level control circuit 10C, a pre-switch a5 performs switching as to which one of the signal having passed through the fader circuit a3 and the signal having not passed through the fader circuit a3 should be input. Level volume control circuit a6, for which a parameter (input C) is set via the parameter setting unit 10A, adjusts the level of the signal sent over the first or second common signal line a2 or a4 in accordance with the parameter (input C). The signal thus adjusted in level by the level volume control circuit a6 is subjected to panning control by a panning volume control circuit a7, and the resultant panning-adjusted signals L and R are output to a bus system 20 via an AUX-ON switch a8. In the monaural input channel 10, four channels of such AUX stereo send level control circuits 10C (i.e., AUX1-AUX4) are provided in parallel as indicated by a dotted-line omission mark.

In the stereo send level control circuits 10D, a panning volume control circuit a9, for which a parameter (input D2) is set via the parameter setting unit 100A, panning-adjusts the output signal from the fader circuit a3. The resultant panning-adjusted L (Left) and R (Right) signals are output from the panning volume control circuit a9 to the bus system 20 via a stereo-ON switch a10.

In an effect control circuit 10E, an effecter all imparts an effect to the signals AUX1-AUX4 in the bus system 20 and outputs the resultant effect-imparted signals to a level volume control circuit a12. The level volume control circuit a12, for which a parameter (input B) is set via the parameter setting unit 100A, adjusts the levels of the output signals from the effecter all. The signals (FX1-FX4) thus adjusted in level by the level volume control circuit a12 are output to the bus system 20. In the monaural input channel 10, four channels of such effect control circuit 10E (i.e., FX1-FX4) are provided in parallel as indicated by a dotted-line omission mark.

To the bus system 20 are connected an AUX stereo output level control circuit (AUX STEREO) 30 and stereo output level control circuit (STEREO) 40. The AUX stereo output level control circuit 30 is provided in corresponding relation to the L and R signals of the AUX stereo send level control circuit 10C, and it outputs the signals to outside the monaural input channel 10 via a mixer circuit a13, fader circuit a14 and AUX-output-ON switch a15. Further, the stereo output level control circuit 40 is provided in corresponding relation to the L and R signals of the stereo send level control circuit 10D, and it outputs the signals to outside the monaural input channel 10 via a mixer circuit a16, fader circuit a17 and stereo-output-ON switch a18.

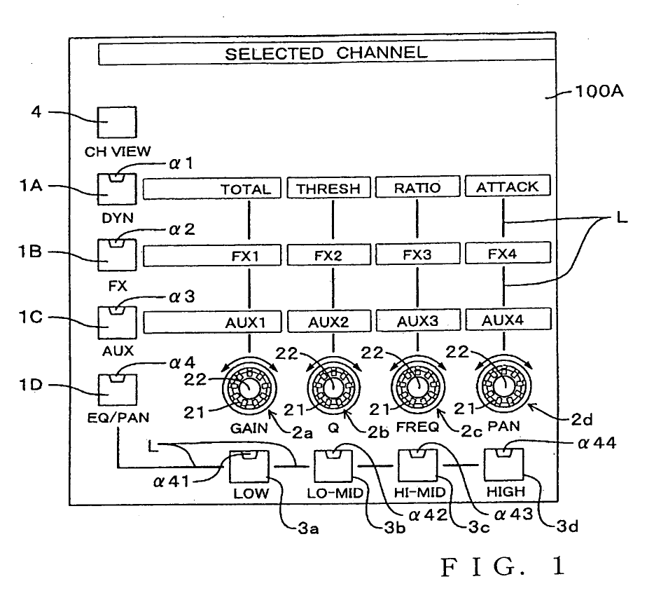

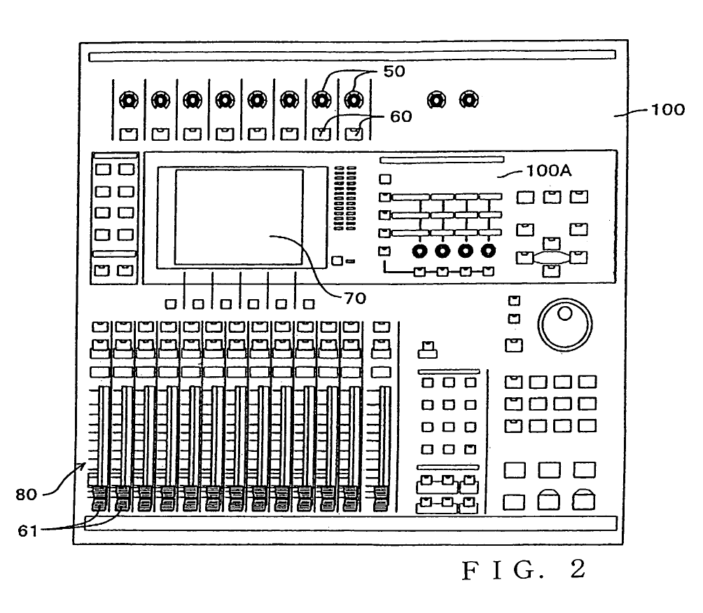

FIG. 1 is an enlarged diagram of the parameter setting unit 100A of the mixing console panel surface 100 in the embodiment of the invention, and FIG. 2 is a diagram showing the entire mixing console panel surface 100. Directions referred to in the following description are directions when the panel surface 100 is viewed head-on. On the mixing console panel surface 100, there are provided volume control operators 50 for adjusting the input level of the monaural input channel 10, operation buttons 60 for operating the channel-ON switch a1, a liquid crystal display 70 for displaying settings of the input channel, the parameter setting unit 100A for setting the above-mentioned various parameters, a slide operator group 80 including a plurality of slide operators 61 for operating the fader circuit a3 of the monaural input channel 10, fader circuit a14 of the AUX stereo output level control circuit 30 and fader circuit a17 of the stereo output level control circuit 40, etc.

As illustrated in FIG. 1, the parameter setting unit 100A includes, as operators of the first operator group, a white-colored DYN selecting operator 1A, red-colored FX selecting operator 1B, blue-colored AUX selecting operator 1C and green-colored EQ/PAN selecting operator 1D disposed vertically near a left side edge of the setting section 10A. The parameter setting unit 100A also includes, as operators of the second operator group, first to fourth volume control operators 2a-2d, including respective built-in rotary encoders, disposed beside the EQ/PAN selecting operators 1D. Further, immediately below respective ones of the volume control operators 2a-2d, there are provided green-colored band selecting operators 3a-3d for selecting a band of desired filter characteristics. Further, immediately above the DYN selecting operator 1A, there is provided a white-colored CHVIEW operator 4 for displaying settings of the channel.

The DYN selecting operator 1A is an operator operable to select, as a setting object, a parameter of the above-mentioned dynamics circuit 10A, and, beside the DYN selecting operator 1A, there are provided letter indications: “TOTAL” indicative of a total output level parameter of an input signal; “THRESH” indicative of a threshold level parameter, “RATIO” indicative of a ratio parameter; and “ATTACK” indicative of an attack parameter. The FX selecting operator 1B is an operator operable to select, as a setting object, a parameter of the level volume control circuit a12 of the effect control circuit 10E, and, beside the FX selecting operator 1B, there are provided letter indications, “FX1”, “FX2”, “FX3” and “FX4”, indicative of parameters of the individual level volume control circuits a12 (FX1-FX4). The AUX selecting operator IC is an operator operable to select, as setting objects, parameters of the individual level volume control circuits a6 of the AUX stereo send level control circuit 10C, and, beside the AUX selecting operator IC, there are provided letter indications, “AUX1”, “AUX2”, “AUX3” and “AUX4”, indicative of parameters of the individual level volume control circuits a6 (AUX1-AUX4).

The EQ/PAN selecting operator 1D is an operator operable to select, as setting objects, parameters of the equalizer circuit 10B and the panning volume control circuit a9 of the stereo send level control circuit 10D. Immediately below respective ones of the volume control operators 2a, 2b, 2c and 2d, there are provided letter indications: “GAIN” indicative of a gain parameter; “Q” indicative of a Q value parameter; “FREQ” indicative of a center frequency parameter; and “PAN” indicative of a panning parameter. Further, immediately below respective ones of the band selecting operators 3a, 3b, 3c and 3d, there are provided letter indications, “LOW”, “LO-MID”, “HI-MID” and “HIGH”, indicative of low, low-middle, high-middle and high frequency bands, respectively.

Further, guide lines L are provided between the above-mentioned indications and the volume control operators 2a-2d and between the EQ/PAN stereo send level control circuit 10D and the band selecting operators 3a-3d. Thus, the guide lines L indicate that the first volume control operator 2a corresponds to “TOTAL”, “FX1”, “AUX1” and “GAIN”, the second volume control operator 2b corresponds to “THRESH”, “FX2”, “AUX2” and “Q”, the third volume control operator 2c corresponds to “RATIO”, “FX3”, “AUX3” and “FREQ” and the fourth volume control operator 2d corresponds to “ATTACK”, “FX4”, “AUX4” and “PAN”. The guide lines L also indicate that the band selecting operators 3a-3d corresponding to “LOW”, “LO-MID”, “HI-MID” and “HIGH” are operators pertaining to “EQ” (equalizer) of the EQ/PAN selecting operator 1D.

The DYN selecting operator 1A, FX selecting operator 1B, AUX selecting operator IC, EQ/PAN selecting operator 1D and band selecting operators 3a-3d are provided with respective indicators α (α1-α4, and α41-α44) each in the form of an LED lamp or the like; each of the indicators α is illuminated as the corresponding operator is depressed (i.e., the corresponding switch is turned on). Whereas the ON/OFF state of each of the operators can also be confirmed through the depressed/projected state thereof, the illumination of the indicator a allows the human operator to readily identify the ON state of the corresponding switch. In the illustrated example, each of the indicators α41-α44 is illuminated in the same color as the operating surface and/or indicator α4 of the EQ/PAN selecting operator ID.

As will be later described in detail, each of the volume control operators 2a-2d includes a light guide member 22 provided at the center of its knob 21, and, in response to operation of the DYN selecting operator 1A, FX selecting operator 1B, AUX selecting operator 1C or EQ/PAN selecting operator 1D, the light guide members 22 are illuminated in “white”, “red”, “blue” or “green”, corresponding to the color of the operated selecting operator 1A, 1B, 1C or 1D. Thus, which of the selecting operators 1A-1D is currently in the selected (or operated) state can be intuitively identified from the illuminated color of the volume control operator 2a-2d or selecting operator 3a-3d; therefore, the indicators α1-α4 may be dispensed with. Note that, in the illustrated example, only one of the selecting operators 1A-1D can be selectively depressed at a time; namely, two or more of the operators 1A-1D can be depressed simultaneously.

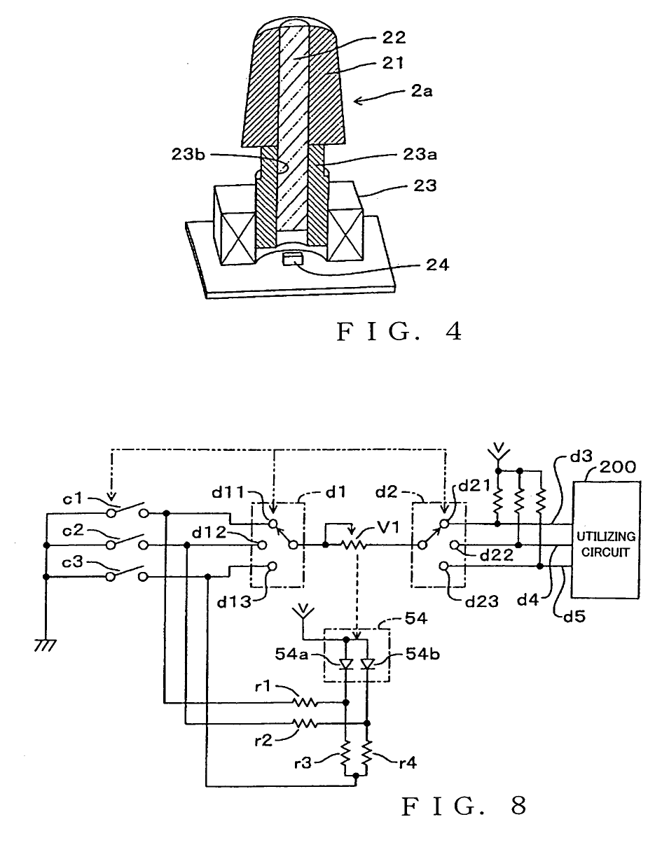

FIG. 4 is a partially-broken-away perspective view of one of rotary volume control devices having the volume control operators 2a-2d. Note that all of the rotary volume control devices are constructed similarly, and a description will be made representatively about one of the rotary volume control devices which has the volume control operator 2a. In this rotary volume control device, the volume control operator 2a is provided on a rotation shaft 23a of a rotary encoder 23, and it has the rod-shaped light guide member 22 fixedly fitted in the center of the knob 21. Specifically, the rotation shaft 23a of the rotary encoder 23 has a vertical axial hole 23b centrally formed therein, and the light guide member 22 of the volume control operator 2a is fixedly fitted in the axial hole 23b. As the volume control operator 2a is rotated, the rotary encoder 23 can generate a signal corresponding to the rotation of the operator 2a. Further, a multi-color LED device 24, which is provided immediately beneath the vertical axial hole 23b, comprises a red LED, green LED and blue LED and can emit many colors by various combinations of the individual LEDs. In an alternative, the multi-color LED device 24 may comprise only LEDs of two colors, such as red and green LEDs, although the available color range is limited. Light emitted by the multi-color LED device 24 is directed through the light guide member 22 up to the top of the volume control operator 2a (2b-2d), and the top of the volume control operator 2a (2b-2d) is illuminated on the parameter setting unit 100A for visual identification by the human operator.

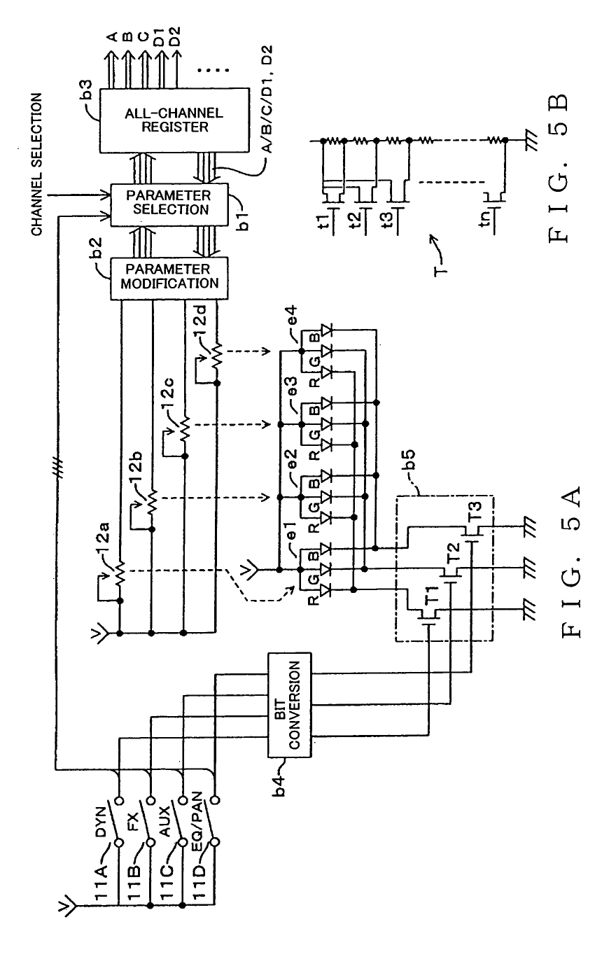

FIG. 5A is a circuit diagram of the parameter setting unit 100A. Switch circuits 11A, 11B, 11C and 11D, which are turned on/off via the DYN selecting operator 1A, FX selecting operator 1B, AUX selecting operator 1C and EQ/PAN selecting operator 1D, are connected in parallel with a reference voltage V. ON signal of each of the switch circuits 11A, 11B, 11C and 11D is set at an H (high) level while an OFF signal of each of the switch circuits 11A, 11B, 11C and 11D is set at an L (low) level, and these ON/OFF signals are each delivered, as a 4-bit bit signal to a parameter selection circuit b1 and bit conversion circuit b4. Only one of the switch circuits 11A, 11B, 11C and 11D is selectively turned on at a time by operation of any one of the corresponding selecting operators 1A-1D, so that only one of the bits of the bit signal is set at the H level with the other three bits set at the L level.

Further, encoder circuits 12a, 12b, 12c and 12d of the rotary encoder 23, which are driven via the above-mentioned volume control operators 2a-2d, are connected in parallel with the reference voltage V, and these encoder circuits 12a, 12b, 12c and 12d output signals, corresponding to rotating directions and rotating amounts of the associated volume control operators 2a-2d, to a parameter modification circuit b2. The parameter modification circuit b2 stores parameters read out from an all-channel register circuit b3, modifies the stored parameters in accordance with output signals from the encoder circuits 12a, 12b, 12c and 12d, and outputs the modified parameters to the parameter selection circuit b1.

The all-channel register circuit b3 comprises a group of registers for storing parameters of all channels selectable with respect to the parameter setting unit 100A. On the basis of a channel selection signal indicative of a currently-selected channel, the parameter selection circuit b1 selectively reads out, from the all-channel register circuit b3, a parameter of the type designated by the above-mentioned 4-bit bit signal, for the currently-selected channel. The thus read-out parameter is set into the parameter modification circuit b2. Namely, the parameter selection circuit b1 sets, into the parameter modification circuit b2, a parameter selected from among a parameters pertaining to the DYN selecting operator 1A (“A”), parameter pertaining to the FX selecting operator 1B (“B”), parameter pertaining to the AUX selecting operator IC (“C”) and parameters pertaining to the EQ/PAN selecting operator 1D (“D1” and “D2”). Then, the selected parameter is modified by the parameter modification circuit b2, and a corresponding one of the registers in the all-channel register circuit b3 is rewritten, via the parameter selection circuit b1, in accordance with the thus-modified parameter.

In this way, output A, output B, output C, output D1 and output D2 from the all-channel register circuit b3 are input and set into the circuitry (utilizing circuitry) of FIG. 3. Output A is input as various parameters to the dynamics circuit 10A, output B is input as parameters to the level volume control circuit a12 of the effect control circuit 10E, and output C is input as parameters to the level volume control circuit a6 of the AUX stereo send level control circuit 10C. Further, output D1 corresponding to the encoder circuits 12a, 12b and 12c is input as various parameters for setting filter characteristics of the equalizer circuit 10B, and output D2 corresponding to the encoder circuit 12d is input as a parameter to the panning volume control circuit a9 of the stereo send level control circuit 10D.

In the foregoing manner, parameters selected via the DYN selecting operator 1A, FX selecting operator 1B, AUX selecting operator IC and EQ/PAN selecting operator ID are modified by operation of the volume control operators 2a-2d, so that parameters of FIG. 3 are set. Further, once another channel is selected with respect to the parameter setting unit 100A and any one of the selecting operators 1A-1D is selected, current parameters of the type corresponding to the operated selecting operator are set for the other channel in correspondence with the volume control operators 2a-2d and updated in response to operation of the volume control operators 2a-2d. The parameters of the selected channel are displayed on the liquid crystal display 70.

In FIG. 5A, the bit conversion circuit b4 converts the 4-bit bit signal, input from the switch circuits 11A-11D, into a bit signal of three bits, and the converted bit signal output from the bit conversion circuit b4 indicates a surface color of the operator 1A-1D corresponding to one of the switch circuits 11A-11D which is currently in the ON state. The 3-bits of the bit signal from the bit conversion circuit b4 are supplied as respective gate signals to FET circuits T1, T2 and T3 of an LED drive circuit b5.

Multi-color LED devices e1, e2, e3 and e4 shown in FIG. 5A each comprise the Multi-color LED device 24 explained above in relation to FIG. 4, and “R”, “G” and “B” indicate red, green and blue LEDs, respectively. The LEDs of the same colors, “R”, “G” and “B”, are connected in parallel. Each of the red LEDs is connected between the reference voltage V and the FET circuit T1, each of the green LEDs is connected between the reference voltage V and the FET circuit T2, and each of the blue LEDs is connected between the reference voltage V and the FET circuit T3. Once any of the FET circuits T1-T3 is turned on in response to the bit signal from the bit conversion circuit b4, the LEDs corresponding to the turned-on FET circuit are illuminated. The Multi-color LED devices e1, e2, e3 and e4 can be illuminated in any one of seven colors: red; green; blue; yellow (red+green); magenta (red+blue); cyan (green+blue); and white (red+green+blue), in accordance with a combination of colors of the illuminated LEDs.

Specifically, in the instant embodiment, the multi-color LED devices e1, e2, e3 and e4 are illuminated in the following colors. Namely, the multi-color LED devices e1, e2, e3 and e4 are illuminated in “white” when the DYN selecting operator 1A (switch circuit 11A) is ON, in “red” when the FX selecting operator 1B (switch circuit 11B) is ON, in “blue” when the AUX selecting operator 1C (switch circuit 11C) is ON, and in “green” when the EQ/PAN selecting operator 1D (switch circuit 11D) is ON. Namely, the bit conversion circuit b4 converts the 4-bit signal, input from the switch circuits 11A-11D, into a 3-bit bit signal such that the LED devices are illuminated in any one of the above-mentioned colors, and supplies the thus-converted 3-bit bit signal to the FET circuits T1, T2 and T3 of the LED drive circuit b5. The switch circuits 11A-11D, bit conversion circuit b4 and LED drive circuit b5 together constitute a “color change control section”.

Whereas the embodiment has been described above in relation to the case where the multi-color LED devices e1, e2, e3 and e4 are illuminatable in the above-mentioned seven colors, the multi-color LED devices e1, e2, e3 and e4 may be illuminated in more than seven colors. In such a case, the FET circuits T1-T3 of the LED drive circuit b5 shown in FIG. 5A are replaced with multiplexed FET circuitry T shown in FIG. 5B, and voltages to be applied to the LEDs of the respective colors, “R”, “G” and “B”, are controlled by ON/OFF-controlling individual FET circuits t1-tn. Because respective luminance levels of the LEDs can be controlled for each of the colors, “R”, “G” and “B” in this way, the multi-color LED devices e1, e2, e3 and e4 can be illuminated in even more colors in accordance with combinations of the luminance levels. The ON/OFF control of the individual FET circuits t1-tn of the multiplexed FET circuitry T may be performed by generating a signal of a plurality of bits, through a table or the like, in accordance with the output from the bit conversion circuit b4, i.e. the signal indicative of the currently-turned-on selecting operator of the switch circuits 11A-11D, such that the LED devices are illuminated in the same color of the currently-turned-on operator and then applying the thus-generated signal to the individual FET circuits t1-tn.

The embodiment has been described above in relation to the case where the rotary encoder 23 of the rotary volume control device shown in FIG. 4 constitutes a “fixed section”, the multi-color LED device 24 a “light emitting device” and the volume control operator 2a (2b-2d) a “movable section” rotationally movable relative to the “fixed section”, the parameter setting apparatus of the present invention may also be applied to the slide operator for setting the fader circuit or the like, and the slide volume control device.

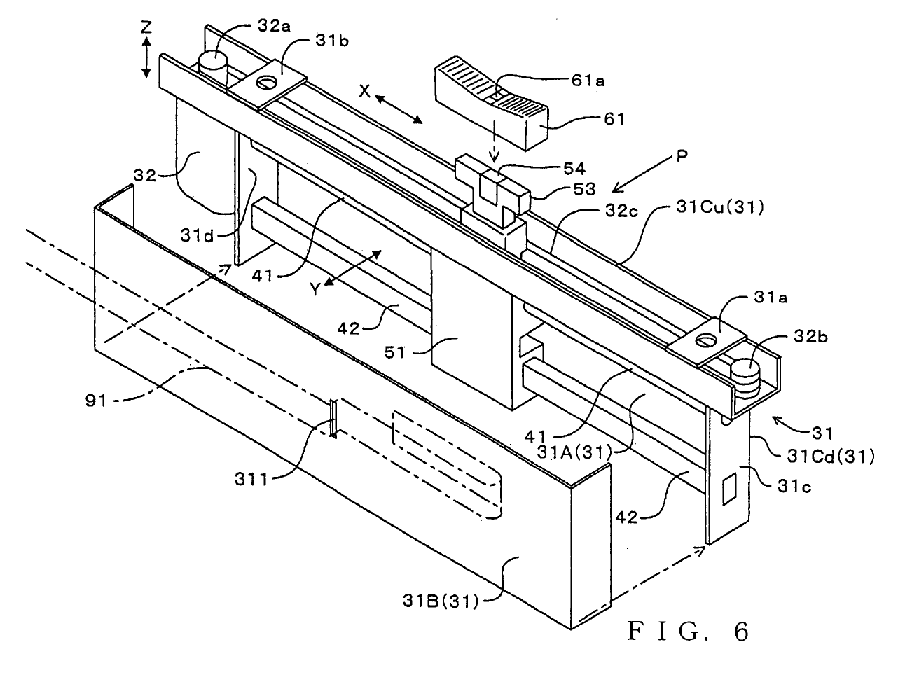

FIG. 6 is an exploded perspective view showing an embodiment of the slide volume control device that includes a frame assembly 31 as a “fixed section” that includes side plates 31A and 31B each having an underside making a right angle with the panel surface 100 and two frames 31Cu and 31Cd, each having a channel-like sectional shape, having their respective channel portions Z and Y extending perpendicularly to each other. The frame 31Cd is mounted in such a manner as to cover, from above, upper and opposite ends of the side plates 31A and 31B, and the frame 31Cu is mounted on the upper surface of the frame 31Cd. Motor 32 is secured to one end of the upper frame 31Cu, and the entire frame assembly 31 is secured to the backside of the front panel surface 100 by means of opposite metal fasteners 31a and 31b of the upper frame 31. The side plate 31B has a lead wire takeout opening 311 formed therein for pulling out a flat cable 91 applied to a later-described non-contact-type slide volume control device. Further, a pair of first and second movement guides 41 and 42 are secured and extend in parallel relation to each other between opposite end surfaces 31c and 31d of the lower frame 31Cd, in a longitudinal direction X of the side plate 31A. The first movement guide 41 is a metal member having a round cross section, while the movement guide 42 is a metal member having a square cross section. On these first and second movement guides 41 and 42 is mounted a moving block 51, forming part of the “movable section”, for sliding movement on and along the length of the movement guides 41 and 42.

Driving pulley 32a is mounted on a drive shaft of the motor 32 disposed at one end portion of the frame 31Cu, and a driven pulley 32b is provided at another end portion of the frame 31Cu. Timing belt 32c is wound on the driving pulley 32a and the driven pulley 32b, and the moving block 51 is connected at its upper portion to a portion of the timing belt 32c. Thus, as the motor 32 is rotated in forward and reverse directions, the moving block 51 is caused to reciprocatively move along the first and second movement guides 41 and 42. The movement of the moving block 51 takes place, for example, when another channel or another function has been allocated to the slide volume control device (i.e., fader), in order to automatically set a position of the slide operator 61 so as to correspond to a parameter of the assigned channel or function.

FIG. 7 is a perspective view of a principal portion of the moving block 51 relevant to the present invention, which is taken in a direction of arrow P shown in FIG. 6. The moving block 51 has an axial hole 51a in which the first movement guide 41 is fitted, and axial holes 51b in which the second movement guide 42 is fitted. The moving block 51 also has a substrate holding portion 51c that is spaced apart from the second movement guide 42 and has a surface dented inwardly of the axial holes 51b. Substrate 52 is fixedly held by the substrate holding portion 51c, and brush contacts 52a, 52b, 52c and 52d, each formed of a resilient electrically-conductive material, are provided on the substrate 52. Three of the brush contacts 52a, 52b and 52c are coupled to lead wires 52a1, 52b1 and 52c1, and these lead wires 52a1, 52b1 and 52c1 pass through a through-hole 51d and are connected to a multi-color LED device 54 as a “light-emitting device” secured to a lever 53. As seen in FIG. 6, the slide operator 61, having a light guide member 61a opposed to an upper light emitting surface of the multi-color LED device 54, is fixed to the lever 53. In the instant embodiment, the moving block 51, lever 53 and slide operator 61 together constitute a “movable section”.

As seen in a balloon indicated by a two-dots-dash line in a lower area of FIG. 7, where the components are shown in horizontally reversed relation to the illustration in a central or main area of FIG. 7, LED wire patterns 42a, 42b and 42c respectively contacting the brush contacts 52a, 52b and 52c, and a wire pattern 42d and volume resistance pattern 42e contacting a same brush contact 52d, are formed on and along the full length of the movement guide 42. The LED wire patterns 42a, 42b and 42c and wire pattern 42d comprise wires of substantially zero resistance and are connected to a not-shown circuit, so that these wires supply a drive current to the multi-color LED device 54 via the brush contacts 52a, 52b and 52c held in constant contact with the wire patterns 42a, 42b and 42c. As seen in a balloon indicated by a two-dots-dash line in an upper area of FIG. 7, the multi-color LED device 54 comprises a red LED 54a and green LED 54b, and a common line 541 of these two LEDs 54a and 54b is connected to the LED wire pattern 42a via the lead wire 52a1 and brush contact 52a. Individual lines 54a1 and 54b1 are connected to the LED wire patterns 42b and 42c, respectively, via the lead wires 52b1, 52c1 and brush contacts 52b, 52c.

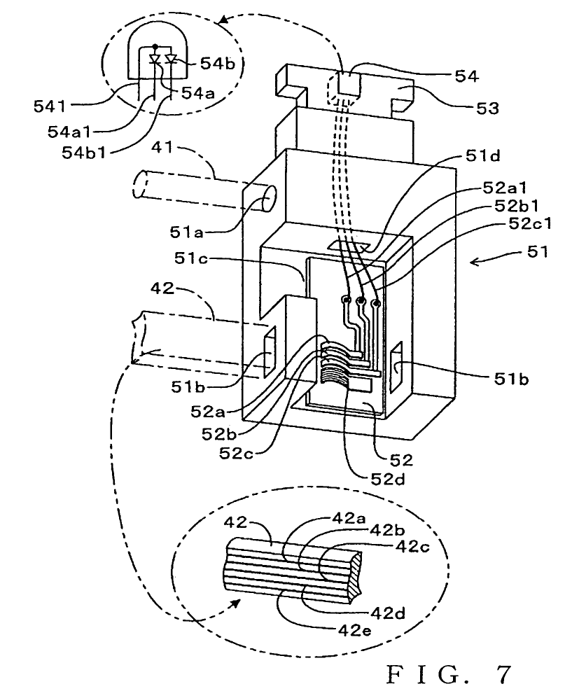

The volume resistance pattern 42e has a predetermined resistance value per unit length, and this resistance pattern 42e and wire pattern 42d are connected at their respective one ends to a voltage detection circuit of a not-shown circuit. Further, the volume resistance pattern 42e and wire pattern 42d are always short-circuited via the brush contact 52d at the position of the brush contact 52d, and they function as a later-described volume control circuit V1 (see FIG. 8) indicating a resistance value in accordance with a distance from the end connected to the voltage detection circuit to the position of the brush contact 52d. In this way, the position of the brush contact 52d relative to the second movement guide 42, i.e. the position of the slide operator 61, is detected via the voltage detection circuit.

FIG. 8 is a circuit diagram of the parameter setting apparatus using the above-described slide volume control device. The illustrated circuitry is constructed to switch the slide volume control device among a plurality of (three in this example) functions and sets the switched-to or selected function. The parameter setting apparatus includes switch circuits c1, c2, c3 and selector circuits d1, d2 operating in interlocked relation to not-shown function selection switches. Whereas the parameter setting apparatus is shown in FIG. 8 as circuitry corresponding to one slide volume control device, similar circuitry is provided for each of a plurality of slide volume control devices corresponding to a plurality of the operators 61 of the slide operator group 80. The same function selected via one of the function selecting switches is set to the other slide volume control devices. The following paragraphs describe only one of the slide volume control devices.

The switches c1, c2 and c3 are connected at their respective one ends to the ground and at their respective other ends to selection terminals d11, d12 and d13, respectively, of a selector circuit d1. The volume control circuit V1 of the slide volume control device is connected between respective common contacts of the selector circuits d1 and d2. Selection terminals d21, d22 and d23 of the selector circuit d2 are connected in parallel with the reference voltage and utilizing circuitry 200. Signal lines d3, d4 and d5 serve to supply, as parameters, respective voltage signals to given points in the utilizing circuitry 200 in accordance with any one of functions (1), (2) and (3). Further, the red LED 54a and green LED 54b of the multi-color LED device 54 are connected at their respective one ends to the reference voltage and at their respective other ends to the ground via resistors r1, r2 and switch circuits c1, c2 and via resistors r3, r4 and switch circuit c3. The resistors r1-r4 are current limiting resistors for the LEDs.

Once function (1) is selected, the switch circuit c1 is turned on (i.e., closed), and the selection terminal d11 of the selector d1 and the selection terminal d21 of the selector d2 are connected to the volume control circuit V1. Once function (2) is selected, the switch circuit c2 is turned on (i.e., closed), and the selection terminal d12 of the selector d1 and the selection terminal d22 of the selector d2 are connected to the volume control circuit V1. Further, once function (3) is selected, the switch circuit c3 is turned on (i.e., closed), and the selection terminal d13 of the selector d1 and the selection terminal d23 of the selector d2 are connected to the volume control circuit V1. Namely, a voltage signal corresponding to a resistance value of the volume control circuit V1 is generated in response to operation of the slide volume control device, and the thus-generated voltage signal is supplied to the utilizing circuitry 200 over the signal line d3 when function (1) has been selected, over the signal line d4 when function (2) has been selected, or over the signal line d5 when function (3) has been selected.

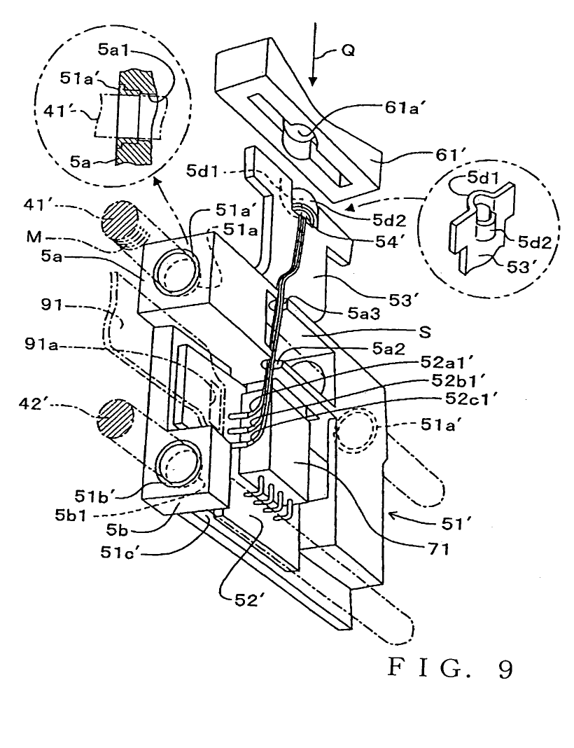

When function (1) has been selected, only the red LED 54a is illuminated, and, when function (2) has been selected, only the green LED 54b is illuminated. When function (3) has been selected, both the red LED 54a and the green LED 54b are illuminated. In this way, the light guide member 61a of the slide operator 61 is illuminated in “red” when function (1) has been selected, in “green” when function (2) has been selected, and in “yellow (i.e., red+green)” when function (3) has been selected. From the illuminated color of the light guide member 61a, it is possible to readily confirm which one of the functions is currently selected. In the instant embodiment, the switch circuits c1, c2 and c3 together constitute a “color change control section”.

Whereas the second embodiment of the present invention has been described above in relation to the case where the multi-color LED device 54 comprises two LEDs, i.e. red and green LEDs 54a and 54b, the multi-color LED device 54 may comprise three LEDs, i.e. red, green and blue LEDs as in the first embodiment. In such a case, the multi-color LED device 54 can be illuminated in many colors in corresponding relation to many functions, with similar arrangements to those of FIG. 5A or 5B.

Whereas FIG. 7 shows the slide volume control device of a contact type, FIG. 9 shows, in a fragmentary perspective view, another embodiment of the slide volume control device that is of a non-contact type. The embodiment of the slide volume control device shown in FIG. 9 is different from the slide volume control device shown in FIG. 7 in that a magnetic sensor 71 is mounted on a substrate 52′ of a moving block 51′, in that a magnetic pole pattern M is formed on a first movement guide 41′, and in that the flat cable 91 is connected to the substrate 52′. In other respects, the embodiment of the slide volume control device in FIG. 9 is generally similar to the counterpart of FIGS. 6 and 7. Therefore, FIG. 9 shows only principal portions, where components corresponding to those in the embodiment of FIG. 7 are indicated by the same reference numerals as in FIG. 7 but with marks “′” added thereto.

In the embodiment of FIG. 9, the first and second movement guides 41′ and 42′ are each in the form of a metal member of a round cross section, and the moving block 51′, constituting part of the “movable section”, is mounted on the first and second movement guides 41′ and 42′ for sliding movement in the longitudinal direction of the guides 41′ and 42′. In this embodiment too, the frame assembly 31, comprising the side plates 31A, 31B and frames 31Cu, 31Cd, constitutes the “fixed section”. Although a rectangular opening (hole) S is formed, in a middle region of an upper guide holding portion 5a of the moving block 51′, to facilitate the formation of the moving block 50′, this opening S may be dispensed with.

As seen from a balloon indicated by a two-dot-dash line in FIG. 9, the guide holding portion 5a has two holding holes 5a1 formed at opposite ends thereof and communicating with the rectangular opening S, and holding ring portions 51a′ fitted in the holding holes 5a1. Substrate holding portion 51c′ extends downward from the underside of the guide holding portion 5a, and a lower guide holding portion 5b has a holding hole 5b1 having a holding ring portion 51b′ fitted therein. The first movement guide 41′ is fitted in the guide holding portion 5a through the holding ring portions 51a′ and opening S, and the second movement guide 42′ is fitted in the guide holding portion 5b through the holding ring portion 51b′. Each of the holding ring portions 51a′ and 51b′ has a smooth inner surface so that the moving block 51′ can smoothly slide along the movement guides 41′ and 42′.

Substrate 52′ is attached to the substrate holding portion 51c′ and has a magnetic sensor 71 mounted thereon. The flat cable 91 is connected at one end to the substrate 52′ via a terminal portion 91a, and lead wires 52a1′, 52b1′ and 52c1′ are also connected to the substrate 52′. Lever 53′ has, at it upper end, semicircular LED holding portions 5d1 and 5d2 formed in vertical succession and projecting in generally opposite horizontal directions, and a multi-color LED device 54′ is attached, as a “light emitting device”, to the LED holding portions 5d1 and 5d2. The lead wires 52a1′, 52b1′ and 52c1′ are adhesively secured to recessed portions 5a2 and 5a3, formed in regions of the guide holding portion 5a opposed to the frame 31A, by a rubber adhesive in such a manner that the lead wires can be removed by pulling the same. The lever 53′ also has a slide operator 61′ attached to its top, and the slide operator 61′ includes a light guide member 61a′ opposed to an upper light irradiating surface of the multi-color LED device 54′. In the instant embodiment, the moving block 51′, lever 53′ and slide operator 61′ together constitute a “movable section”. In an alternative, the light guide member 61a′ may be dispensed with so that the multi-color LED device 54′ is exposed directly to the outside.

Further, the magnetic sensor 71, for example in the form of an IC including hall elements (or MR (Magnetic Resonance) sensor), is mounted on the substrate 52′, and the magnetic sensor 71 has a sensing surface opposed to the first movement guide 41′ with a slight gap (clearance) left therebetween. Output line of the magnetic sensor 71 and the lead wires 52a1′, 52b1′ and 52c1′ of the multi-color LED device 54′ are connected to the outside. The multi-color LED device 54′ is illuminated by a current supplied over the flat cable 91. Electric power is supplied via the flat cable 91 to the magnetic sensor 71, and detection signals of the magnetic sensor 71 are delivered via the flat cable 91 to a not-shown circuit as will be later described.

The first movement guide 41′ is made of an alloy that is formed by mixing a base material of iron with nickel and cobalt. Therefore, the first movement guide 41′ can maintain original properties of iron itself, and thus, it is highly resistant to breakage and also assumes springy characteristics such that it can automatically spring back even when it has been slightly bent. Namely, the movement guide 41′ is resistant to breakage due to external pressure and can effectively prevent breakage of the device as compared to a case where the movement guide is made of a ferrite magnet that is rather easy to break.

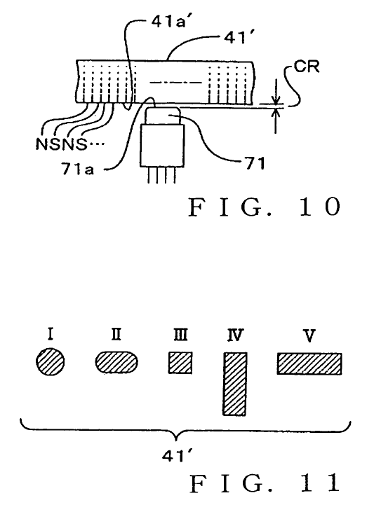

As illustrated in FIG. 10, the first movement guide 41′ is formed as a magnet having a multiplicity of fine N and S magnetic poles arranged alternately along its length. Namely, the first movement guide 41′ is formed as a high-resolution magnet where a pitch between every adjacent N magnetic poles is 100 μm (50 μm between every adjacent N and S magnetic poles). The magnetic sensor 71 is, for example, in the form of an IC including hall elements (or MR (Magnetic Resonance) sensor), and the sensing surface 71a of the magnetic sensor 71 is opposed to a pole face 41a′ of the first movement guide 41′ with a slight gap or clearance in the order of 0.1-0.2 mm. Magnetic field of the pole face 41a′ is detected by the magnetic sensor 71, so that detection signals are generated from the magnetic sensor 71.

Namely, as the magnetic sensor 71 moves relative to the pole face 41a′ of the first movement guide 41′ in accordance with movement of the moving block 51′, the magnetic sensor 71 outputs pulse signals corresponding to polarity reversals between the N and S magnetic poles. On the basis of the number of the pulse signals, it is possible to detect a traveled amount (distance) of the moving block 51′. Further, the magnetic poles of the pole face 41a′ may be arranged in, for example, two rows of magnetic pole patterns that are phase-shafted from each other by an amount corresponding to ½ π in the longitudinal direction of the first movement guide 41′, so that the magnetic sensor 71 outputs phase-shifted pulse signals. Thus, on the basis of a positive or negative direction of the phase shift in the signals, it is possible to detect a moving direction of the magnetic sensor 71. In an alternative, the magnetic poles of the pole face 41a′ may be arranged in “NSNS” patterns with no phase shift, and, instead, pole detection sections of the magnetic sensor 71 may be provided with a phase shift corresponding to ½ π. Further, because position information indicative of positions of the moving block 51′ before movement is constantly stored via a control circuit or the like, it is possible to detect a position of the moving block 51′, i.e. a position of the slide operator 61′, in the entire slide volume control device, on the basis of the position information as well as the moving amount and direction.

As the human operator manually operates the slide operator 61′ to move (slide) the moving block 51′, the moving block 51′ is generally pressed in a direction of arrow Q indicated in FIG. 9. The magnetic sensor 71 senses the movement guide 41′ itself that holds the moving block 51′ provided with the sensor 71. Thus, even when the movement guide 41′ slightly flexes due to a great pressing force so that the moving block 51′ lowers, the above-mentioned clearance CR between the sensing surface 71a and the pole surface 41a′ of the first movement guide 41′ can be kept constant, which can thereby prevent the pressing force from adversely influencing the detection accuracy. Generally, if the clearance CR varies, levels etc. of the detection signals would vary so that the detection accuracy would drop; however, the instant embodiment arranged in the above-described manner can reliably avoid such an inconvenience.

Further, as depicted in FIG. 10 by progressively-thickening dotted lines, the first movement guide 41′ is magnetized with greater intensity in the pole surface 41a′ than in its interior regions; however, in the embodiment, the magnetization intensity may be relatively small as a whole. Namely, because the clearance CR between the sensing surface 71a and the pole surface 41a′ of the first movement guide 41′ can be kept constant, the clearance CR itself can be formed as a small clearance. Thus, if the magnetic sensor 71 is set to the same sensitivity as where the clearance CR is relatively great, the magnetization or polarization of the movement guide 41′ itself may be weaker than in the case where the clearance CR is relatively great; namely, low magnetization intensity of the pole surface 41a′ suffices in the instant embodiment. In this case, the magnetization intensity only has to be such that the pole surface 41a′ can be magnetized to a minimum necessary magnetic force such that a dead zone or non-operating zone for sensing by the magnetic sensor 71 and pole surface 41a′ can be avoided during application of a normal pressing force or normal operation; besides, stabilized sensing is permitted even when a great pressing force is applied. As stated above, the instant embodiment is constructed to achieve an enhanced sensitivity and detection accuracy with a small clearance CR between the sensing surface 71a and the pole surface 41a′ of the first movement guide 41′. Note that a clearance between the second movement guide 42′ and moving block 51′ does not substantially influence the detection sensitivity and accuracy even if the clearance is relatively great; thus, even relatively-rough designing will suffice, and, in addition, the necessary cost can be reduced considerably.

FIG. 11 is a sectional view showing modifications of the movement guide. The movement guide 41′ in the above-described embodiments is in the form of an elongated rod having a round cross section as illustrated at I. II in FIG. 11 shows a modified movement guide in the form of a rod having a racetrack or horizontally-elongated oblong cross section, III shows another modified movement guide in the form of a rod having a square cross section, IV shows still another modified movement guide in the form of a rod having a vertically-elongated rectangular cross section, and V shows still another modified movement guide in the form of a rod having a horizontally-elongated rectangular cross section. The moving block has guide holding holes corresponding in cross-sectional shape to the movement guides. However, where the modified movement guide shown at IV or V is employed, only one such movement guide will suffice. Namely, the above-described second movement guide 42′ performs an auxiliary function for preventing the moving block 51′ from undesirably turning (rolling) about the first movement guide 41′. However, the modified movement guide shown at IV or V of FIG. 11 can by itself prevent the rolling of the moving block, eliminating the need for the second movement guide 42′.

Whereas the first movement guide 41′ is a breakage-resistant member made of an alloy that is formed by mixing the base material of iron with nickel and cobalt as set forth above, it may be made by fixing a ferrite magnet to the underside of a soft iron material. In this way, each of the movement guides II-V of FIG. 11 can be made with an increased ease. For example, because it just suffices to magnetize one of the surfaces of the movement guide which is opposed to the magnetic sensor, the fixing of the ferrite magnet will not result in a reduction in magnetization intensity of the ferrite magnet. For example, only three percent of the underside region of the movement guide 41′ is magnetized with the upper surface region having almost no magnetic force.

In the above-described second embodiment, the lower guide holding portion 5b and holding ring portion 51b′ of the moving block 51′ are constructed to fit over the entire outer circumference of the second movement guide 42′. Alternatively, either one of the left and right sides of the guide holding portion 5b (and holding ring portion 51b′) may be opened with respect to the movement guide 42′; even in such an alternative, the movement guide 42′ will not come off the guide holding portion 5b because of the presence of the side plate. In another alternative, the lower portion of the guide holding portion 5b (and holding ring portion 51b′) may be opened; with this alternative, the necessary assemblying operations can be facilitated. Further, the lower guide holding portion 5b need not necessarily have the holding ring portion 51b′.

Furthermore, because the magnetic detection is employed in the above-described embodiments, the detection accuracy will not deteriorate even when the sensing surface of the magnetic sensor 71 or pole surface 41a′ has tarnished or smudged or dust has got in the clearance; thus, there can be provided a slide volume control device impervious to smudge, tarnish, dust, etc.

Further, the side plate 31B has the vertically-elongated lead wire takeout opening 311 formed in the longitudinal middle thereof (i.e., the middle in the sliding movement stroke of the moving block 51′), as described earlier in relation to FIG. 6. The flat cable 91 connected to the magnetic sensor 71 and multi-color LED device 54′ is drawn from the substrate 52′, folded back 180° and then drawn out of the side plate 31B through the lead wire takeout opening 311. With the lead wire takeout opening 311 formed in the longitudinal middle, a portion of the flat cable 91 located inward of the lead wire takeout opening 311 only has to have a length corresponding to about a half of the entire sliding stroke of the moving block 51′. Further, the folding-back of the flat cable 91 allows the flat cable 91 to be accommodated in the case 31 with ease. Thus, the flat cable 91 can also be lightly fixed at or near the lead wire takeout opening 311, so that, when the moving block 51′ has moved, the flat cable 91 does not dangle, as viewed from outside the side plate 31B, like an ordinary cable connected to a printer head; as a consequence, the flat cable 91 can be neatly accommodated within the slide volume control device.

Whereas the non-contact-type detection is made in a magnetic manner in the above-described embodiments, it may be made in an optical manner. In such a case, the example of FIG. 9 is constructed to provide, in the underside of the first movement guide 41′ (corresponding to the pole surface 41a′), two rows of constant-period patterns in the form of, for example, white-and-black barcodes and provide, instead of the magnetic sensor 71, a photo sensor comprising a light emitting diode and photo diode so that pulse signals with a phase difference corresponding to the two rows of the white-and black patterns can be obtained as detection signals. In the case of this optical scheme too, the electric power supply to the multi-color LED device 54′ and photo sensor is performed via the flat cable 91. Also, because the photo sensor senses the first movement guide 41′ itself, the clearance (gap) between the photo sensor and the pattern surface can be kept constant despite application of a pressing force, with the result that the optical scheme can achieve a high detection accuracy similarly to the magnetic scheme.

With each of the above-described magnetic and optical schemes, the guide holding portion 5a functions as a stopper functioning in the pressing force (arrow Q direction) during operation, so that the moving block 51′ can be restricted to a constant positional range, in the pressing direction, relative to the movement guide 41′, which not only can enhance the operational feeling (sliding feeling) but also can provide appropriate measures to a vertical load on the entire device.

Circuit diagram of the parameter setting apparatus using the magnetic or optical non-contact-type slide volume control device is similar to that shown in FIG. 8. However, in these embodiments, the volume control circuit V1 of FIG. 8 is an electronic volume for which resistance is set in accordance with detection signals obtained by the magnetic sensor 71 or photo sensor in the slide volume control device, and the human operator can readily confirm which one of the functions is currently selected for the slide volume control device, on the basis of the illuminated color of the multi-color LED device 54′ and light guide member 61a′.

Whereas the embodiments have been described above in relation to the case where sound parameters are set via the mixing console, the basic principles of the present invention may be applied to other equipment to discriminate among operators by their colors, in correspondence with a currently-selected function, in setting a plurality of parameters.

What is claimed is:

1. A parameter setting apparatus comprising:
a selection section that selects any one of a plurality of functions;
an operator group including a plurality of operators, each of the operators in said operator group being operable to set a type of parameter among a plurality of types of parameters pertaining to the one function selected via said selection section;
a color indicator provided in correspondence with at least two or more of the operators in said operator group; and
a color change control section that changes the color to be indicated by said color indicator, wherein specific colors are assigned to individual ones of said plurality of functions, and, in accordance with function selection via said selection section, said color change control section causes said color indicator to indicate the specific color assigned to the selected function.

2. A parameter setting apparatus as claimed in claim 1 wherein said color indicator is provided individually in correspondence with each of at least two or more of the operators.

3. A parameter setting apparatus as claimed in claim 2 wherein each of the color indicators is disposed on or in or near a knob of the corresponding operator.

4. A parameter setting apparatus as claimed in claim 1 wherein said color indicator comprises a multi-color light emitting device.

5. A parameter setting apparatus as claimed in claim 1 wherein said selection section includes a plurality of selecting operators, and each of the selecting operators is operable to select any one of the plurality of functions.

6. A parameter setting apparatus as claimed in claim 5 wherein each of the selecting operators is colored in the specific color assigned to the function corresponding thereto.

7. A parameter setting apparatus as claimed in claim 1 which is used for setting a signal processing parameter in an audio mixer.

8. A parameter setting apparatus as claimed in claim 1 wherein each of said operators includes a fixed section and a movable section so that a parameter value is set by movement of the movable section,
wherein said color indicator includes a multi-color light emitting device provided in the fixed section of said operator and a light guide member provided in the movable section, and light emitted by said multi-color light emitting device is irradiated externally from a surface of the movable section through said light guide member, and
wherein said color change control section causes said color indicator to indicate the specific color assigned to the selected function.

9. A parameter setting apparatus as claimed in claim 8 wherein said operator is a rotary operator where the movable section is rotatable relative to the fixed section.

10. A parameter setting apparatus as claimed in claim 1 wherein each of said operators includes a fixed section and a movable section so that a parameter value is set by movement of the movable section,
wherein said color indicator includes a multi-color light emitting device provided in the movable section of said operator, and
wherein said color change control section causes said color indicator to indicate the specific color assigned to the selected function.

11. A parameter setting apparatus as claimed in claim 10 wherein said operator is a sliding-type operator where the movable section is linearly movable relative to the fixed section.

12. A parameter setting apparatus comprising:
a selection section that selects any one of a plurality of functions;
an operator operable, in accordance with function selection by said selection section, to set a parameter pertaining to the function selected via said selection section, said operator including a fixed section and a movable section so that a parameter value is set by movement of the movable section;
a color indicator provided in correspondence with said operator, said color indicator including a multi-color light emitting device provided in the fixed section of said operator and a light guide member provided in the movable section, light emitted by said multi-color light emitting device being irradiated externally from a surface of the movable section through said light guide member; and
a color change control section that changes the color to be indicated by said color indicator, wherein specific colors are assigned to individual ones of said plurality of functions, and, in accordance with the function selection via said selection section, said color change control section causes said color indicator to indicate the specific color assigned to the selected function.

13. A parameter setting apparatus comprising:
a selection section that selects any one of a plurality of functions;
an operator operable, in accordance with function selection by said selection section, to set a parameter pertaining to the function selected via said selection section, said operator including a fixed section and a movable section so that a parameter value is set by movement of the movable section;
a color indicator provided in correspondence with said operator, said color indicator including a multi-color light emitting device provided in the movable section of said operator; and
a color change control section that changes the color to be indicated by said color indicator, wherein specific colors are assigned to individual ones of said plurality of functions, and, in accordance with the function selection via said selection section, said color change control section causes said color indicator to indicate the specific color assigned to the selected function.

14. A parameter setting method comprising:
a step of selecting any one of a plurality of functions;
a step of setting a type of parameter among a plurality of types of parameters pertaining to the one function selected via said step of selecting, in response to operation of any of a plurality of operators; and
a step of changing a color to be indicated by a color indicator provided in correspondence with at least two or more of the operators, wherein specific colors are assigned to individual ones of said plurality of functions, and, in accordance with function selection via said step of selecting, said step of changing a color causes the color indicator to indicate the specific color assigned to the selected function.

15. A program for causing a computer to perform a parameter setting procedure, said parameter setting procedure comprising:
a step of selecting any one of a plurality of functions;
a step of setting a type of parameter among a plurality of types of parameters pertaining to the one function selected via said step of selecting, in response to operation of any of a plurality of operators; and
a step of changing a color to be indicated by a color indicator provided in correspondence with at least two or more of the operators, wherein specific colors are assigned to individual ones of said plurality of functions, and, in accordance with function selection via said step of selecting, said step of changing a color causes the color indicator to indicate the specific color assigned to the selected function.
